(19) United States
(12) Patent Application Publication
(10) Pub. No.: US 2025/0358661 A1
(43) Pub. Date: Nov. 20, 2025

(54) CONFIGURATION BASED ON MEASUREMENT ACCURACY OF A FILTER

(71) Applicant: Nokia Technologies Oy, Espoo (FI)

(72) Inventors: Umur KARABULUT, Munich (DE); Ahmad AWADA, Munich (DE); Panagiotis SPAPIS, Munich (DE); Alperen GUNDOGAN, Munich (DE); Ali KARIMIDEHKORDI, Munich (DE)

(21) Appl. No.: 18/873,884

(22) PCT Filed: Jun. 2, 2023
(86) PCT No.: PCT/EP2023/064796

§ 371 Date: Dec. 11, 2024

(30) Foreign Application Priority Data
Jun. 14, 2022 (FI) 20225531

(51) Int. Cl. H04W 24/10; H04L 5/00; H04W 76/20

(52) U.S. Cl. CPC H04W 24/10; H04L 5/0053; H04W 76/20

(57) ABSTRACT

There is provided an apparatus comprising at least one processor, and at least one memory including computer program code, the at least one memory and the computer program code configured to, with the at least one processor, cause the apparatus to perform at least: receiving, from a network node, configuration for reporting information on measurement accuracy of a L1 filter in use; transmitting, to the network node, information on measurement accuracy of the L1 filter having an initial measurement accuracy.

### FIELD

Various example embodiments relate to measurement accuracy of a filter and configuration based on measurement accuracy.

### BACKGROUND

In cellular communication systems, a user equipment may be configured to measure signal qualities of a serving cell and neighbour cells. Measurement results from such measurements may be used to decide whether there is a need for a handover of the user equipment from one cell to another.

### SUMMARY

According to some aspects, there is provided the subject-matter of the independent claims. Some example embodiments are defined in the dependent claims. The scope of protection sought for various example embodiments is set out by the independent claims. The example embodiments and features, if any, described in this specification that do not fall under the scope of the independent claims are to be interpreted as examples useful for understanding various example embodiments.

According to a first aspect, there is provided an apparatus comprising at least one processor; and at least one memory including computer program code, the at least one memory and the computer program code configured to, with the at least one processor, cause the apparatus to perform at least: receiving, from a network node, configuration for reporting information on measurement accuracy of a L1 filter in use; transmitting, to the network node, information on measurement accuracy of the L1 filter having an initial measurement accuracy.

According to a second aspect, there is provided an apparatus comprising at least one processor; and at least one memory including computer program code, the at least one memory and the computer program code configured to, with the at least one processor, cause the apparatus to perform at least: receiving configuration of autonomous update of a L3 filter, the configuration comprising instructions to update the L3 filter based on a current measurement accuracy in response to changing a L1 filter having an initial measurement accuracy to another L1 filter having a second measurement accuracy, which is different from the initial measurement accuracy.

According to a third aspect, there is provided an apparatus comprising at least one processor; and at least one memory including computer program code, the at least one memory and the computer program code configured to, with the at least one processor, cause the apparatus to perform at least: a) transmitting, to a user equipment, configuration for reporting information on measurement accuracy of a first filter; and receiving, from the user equipment, information on measurement accuracy of the L1 filter having an initial measurement accuracy; or b) transmitting, to a user equipment, receiving configuration of autonomous update of a L3 filter, the configuration comprising instructions to update the L3 filter based on a current measurement accuracy in response to changing a L1 filter having an initial measurement accuracy to another L1 filter having a second measurement accuracy, which is different from the initial measurement accuracy.

According to a fourth aspect, there is provided an apparatus comprising at least one processor; and at least one memory including computer program code, the at least one memory and the computer program code configured to, with the at least one processor, cause the apparatus to perform at least: receiving information on measurement accuracy of a L1 filter; determining whether to reconfigure a L3 filter based on: the information on measurement accuracy of the L1 filter; and current configuration of the L3 filter; and knowledge of impact of the measurement accuracy of the L1 filter and the configuration of the L3 filter on performance of a cascade of the L1 filter and the L3 filter.

According to a fifth aspect, there is provided a method, comprising: receiving, from a network node, configuration for reporting information on measurement accuracy of a L1 filter in use; transmitting, to the network node, information on measurement accuracy of the L1 filter having an initial measurement accuracy.

According to an embodiment, the L1 filter is a filter of a first layer.

According to an embodiment, the method comprises: receiving, from the network node, reconfiguration of a L3 filter.

According to an embodiment, the reconfiguration comprises increasing a filter coefficient of the L3 filter; or decreasing a filter coefficient of the L3 filter.

According to an embodiment, the L3 filter is a filter of a third layer.

According to an embodiment, the method comprises: updating the L3 filter according to the reconfiguration.

According to an embodiment, the method comprises: changing the L1 filter to another L1 filter having a second measurement accuracy, which is different from the initial measurement accuracy; and transmitting, to the network node, information on the second measurement accuracy.

According to an embodiment, the method comprises: receiving, from the network node, reconfiguration of a L3 filter which has been updated in response to a change in the measurement accuracy of the L1 filter; and updating the L3 filter according to the reconfiguration.

According to a sixth aspect, there is provided a method, comprising: receiving configuration of autonomous update of a L3 filter, the configuration comprising instructions to update the L3 filter based on a current measurement accuracy in response to changing a L1 filter having an initial measurement accuracy to another L1 filter having a second measurement accuracy, which is different from the initial measurement accuracy.

According to an embodiment, the configuration of autonomous update comprises a plurality of different filter coefficients of the L3 filter corresponding to different measurement accuracies.

According to an embodiment, the configuration of autonomous update comprises instructions to scale a filter coefficient of the L3 filter with respect to the current measurement accuracy of the L1 filter.

According to an embodiment, the method comprises: changing the L1 filter to another L1 filter having the second measurement accuracy, which is different from the initial measurement accuracy; and in response to changing, updating the L3 filter according to the configuration of autonomous update.

According to an embodiment, the measurement accuracy of the L1 filter is defined by a measurement accuracy class.

According to a seventh aspect, there is provided a method, comprising a) transmitting, to a user equipment, configuration for reporting information on measurement accuracy of a first filter; and receiving, from the user equipment, information on measurement accuracy of the L1 filter having an initial measurement accuracy; or b) transmitting, to a user equipment, receiving configuration of autonomous update of a L3 filter, the configuration comprising instructions to update the L3 filter based on a current measurement accuracy in response to changing a L1 filter having an initial measurement accuracy to another L1 filter having a second measurement accuracy, which is different from the initial measurement accuracy.

According to an embodiment, the method comprises after option a): transmitting, to another network node (CU), information on measurement accuracy of the L1 filter.

According to an embodiment, the method comprises: receiving, from a network node, configuration for updating a L2 filter configuration based on the received information on the measurement accuracy of the L1 filter or based on received information on a change of the L1 filter to another L1 filter having a second measurement accuracy, which is different from the initial measurement accuracy.

According to an embodiment, the method comprises: receiving, from the user equipment, information on a change of the L1 filter to another L1 filter having the second measurement accuracy, which is different from the initial measurement accuracy; and updating the L2 filter configuration based on the information on the second measurement accuracy.

According to an eighth aspect, there is provided a method, comprising: receiving information on measurement accuracy of a L1 filter; determining whether to reconfigure a L3 filter based on: the information on measurement accuracy of the L1 filter; and current configuration of the L3 filter; and knowledge of impact of the measurement accuracy of the L1 filter and the configuration of the L3 filter on performance of a cascade of the L1 filter and the L3 filter.

According to an embodiment, the method comprises: in response to determining that the L3 filter is to be reconfigured, reconfiguring the L3 filter and transmitting the reconfiguration of the L3 filter.

According to an embodiment, the reconfiguration comprises increasing a filter coefficient of the L3 filter; or decreasing a filter coefficient of the L3 filter.

According to a further aspect, there is provided an apparatus comprising means for performing the method according to the fifth aspect and the embodiments thereof.

According to a further aspect, there is provided an apparatus comprising means for performing the method according to the sixth aspect and the embodiments thereof.

According to a further aspect, there is provided an apparatus comprising means for performing the method according to the seventh aspect and the embodiments thereof.

According to a further aspect, there is provided an apparatus comprising means for performing the method according to the eighth aspect and the embodiments thereof.

According to an embodiment, the means comprises at least one processor; and at least one memory including computer program code, the at least one memory and the computer program code configured to, with the at least one processor cause the performance of the apparatus.

According to a further aspect, there is provided a computer readable medium comprising program instructions that, when executed by at least one processor, cause an apparatus to at least to perform the method according to the fifth aspect and the embodiments thereof.

According to a further aspect, there is provided a computer readable medium comprising program instructions that, when executed by at least one processor, cause an apparatus to at least to perform the method according to the sixth aspect and the embodiments thereof.

According to a further aspect, there is provided a computer readable medium comprising program instructions that, when executed by at least one processor, cause an apparatus to at least to perform the method according to the seventh aspect and the embodiments thereof.

According to a further aspect, there is provided a computer readable medium comprising program instructions that, when executed by at least one processor, cause an apparatus to at least to perform the method according to the eighth aspect and the embodiments thereof.

According to a further aspect, there is provided a computer program configured to cause an apparatus to perform the method according to the fifth aspect and the embodiments thereof, when run on a computer.

According to a further aspect, there is provided a computer program configured to cause an apparatus to perform the method according to the sixth aspect and the embodiments thereof, when run on a computer.

According to a further aspect, there is provided a computer program configured to cause an apparatus to perform the method according to the seventh aspect and the embodiments thereof, when run on a computer.

According to a further aspect, there is provided a computer program configured to cause an apparatus to perform the method according to the eighth aspect and the embodiments thereof, when run on a computer.

### BRIEF DESCRIPTION OF THE DRAWINGS

FIG. 1 shows, by way of example, a network architecture of communication system;

FIG. 2 shows, by way of example, a measurement model of a user equipment;

FIG. 3 shows, by way of example, accuracy-delay impact and tradeoff for cascaded L1 and L3 filter configurations;

FIG. 4a shows, by way of example, a flowchart of a method;

FIG. 4b shows, by way of example, a flowchart of a method;

FIG. 5 shows, by way of example, measurement accuracy requirements of layer 1 filter;

FIG. 6 shows, by way of example, signalling between entities;

FIG. 7 shows, by way of example, a block diagram of an apparatus;

FIG. 8a shows, by way of example, a flowchart of a method;

FIG. 8b shows, by way of example, a flowchart of a method; and

FIG. 9 shows, by way of example, a flowchart of a method.

### DETAILED DESCRIPTION

When considering measurements performed by a user equipment, there may be a tradeoff between accuracy of the measurements and delay of the measurements. A user equipment may be configured to transmit information on measurement accuracy of a filter of a first layer to the network. This enables the network to decide whether a filter of a third layer is to be reconfigured. Methods are herein provided which reduce frequency of mobility failures caused by unnecessarily delayed measurements or extremely inaccurate measurements.

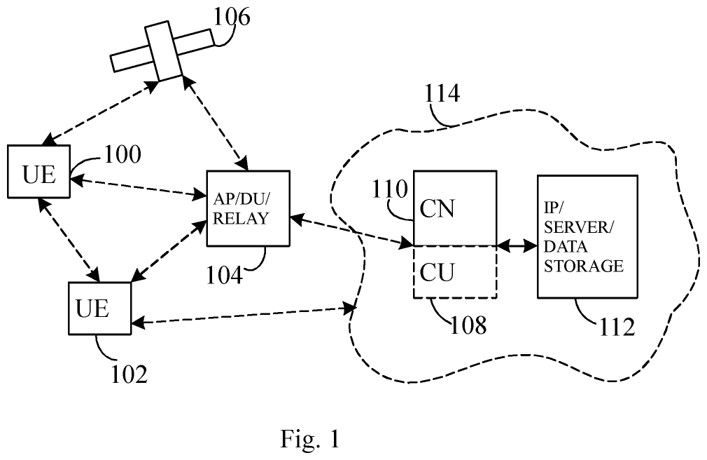

FIG. 1 shows, by way of an example, a network architecture of communication system. In the following, different exemplifying embodiments will be described using, as an example of an access architecture to which the embodiments may be applied, a radio access architecture based on long term evolution advanced (LTE Advanced, LTE-A) or new radio (NR), also known as fifth generation (5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

The example of FIG. 1 shows a part of an exemplifying radio access network. FIG. 1 shows user devices 100 and 102 configured to be in a wireless connection on one or more communication channels in a cell with an access node or network node, such as gNB, i.e. next generation NodeB, or eNB, i.e. evolved NodeB (eNodeB), 104 providing the cell. In some embodiments, access node 104 may be an access point of a non-cellular system. The physical link from a user device to a network node 104 is called uplink (UL) or reverse link and the physical link from the network node 104 to the user device is called downlink (DL) or forward link. It should be appreciated that network nodes or their functionalities may be implemented by using any node, host, server or access point etc. entity suitable for such a usage. A communications system typically comprises more than one network node in which case the network nodes may also be configured to communicate with one another over links, wired or wireless, designed for the purpose. These links may be used for signalling purposes. The network node is a computing device configured to control the radio resources of the communication system it is coupled to. The network node may also be referred to as a base station (BS), an access point or any other type of interfacing device including a relay station capable of operating in a wireless environment. The network node includes or is coupled to transceivers. From the transceivers of the network node, a connection is provided to an antenna unit that establishes bi-directional radio links to user devices. The antenna unit may comprise a plurality of antennas or antenna elements. The network node is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc. An example of the network node configured to operate as a relay station is integrated access and backhaul node (IAB). The distributed unit (DU) part of the IAB node performs BS functionalities of the IAB node, while the backhaul connection is carried out by the mobile termination (MT) part of the IAB node. UE functionalities may be carried out by IAB MT, and BS functionalities may be carried out by IAB DU. Network architecture may comprise a parent node, i.e. IAB donor, which may have wired connection with the CN, and wireless connection with the IAB MT.

The user device, or user equipment UE, typically refers to a portable computing device, such as a wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, connected car connectivity module and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction.

Additionally, although the apparatuses have been depicted as single entities, different units, processors and/or memory units (not all shown in FIG. 1) may be implemented inside these apparatuses, to enable the functioning thereof.

5G enables using multiple input-multiple output (MIMO) technology at both UE and gNB side, many more base stations or nodes than LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 7 GHz, cmWave and mmWave, and also being integratable with existing legacy radio access technologies, such as the LTE. Below 7 GHz frequency range may be called as FR1, and above 24 GHz (or more exactly 24-52.6 GHZ) as FR2, respectively. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 7 GHz-cmWave, below 7 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloud RAN architecture enables RAN real time functions being carried out at the RAN side (in a distributed unit, DU 104) and non-real time functions being carried out in a centralized manner (in a centralized unit, CU 108).

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). Each satellite 106 in the constellation may cover several satellite-enabled network entities that create on-ground cells. The on-ground cells may be created through an on-ground relay node 104 or by a gNB located on-ground or in a satellite.

UE 100 connects to the network through a cell, controlled by network node 104, which provides a good link quality. For example, the link quality may be considered good if the signal-to-interference-noise-ratio (SINR) of the link is above a certain threshold. If the UE moves toward the edge of the serving cell, e.g. by moving further away from network node 104 which controls the serving cell, and gets closer to a neighbour cell, the received signal power of the serving cell degrades and interference from the neighbour cell increases. Eventually, UE 100 hands over to the neighbour cell, or the target cell, to sustain the connection to the network.

UEs 100, 102 measure the quality of the serving cell and neighbour cells. UE measurements are used to decide on handovers of a UE from one cell to another. Such handovers may be hard handovers, where a connection is switched over to a new cell, or soft handovers, where a connection to the new cell is added without relinquishing the connection to the earlier cell. For example, reference signal received power (RSRP) of the serving cell may be compared against that of the target cell to determine whether it is necessary to hand over the connection of the UE from the serving cell to another cell. The received signal power measurements may fluctuate a lot due to channel conditions or hardware impairments, e.g., thermal noise, fast-fading, measurement error, and shadow fading. There is a risk that using those measurements without any filtering leads to suboptimal or inefficient decisions due to rapid fluctuations and uncertainties of the measured signals. Inaccurate cell quality measurements lead to faulty handover decisions in the network and cause UEs to experience service interruption, e.g., radio link failure (RLF), handover failure (HOF) or ping-pong (PP), repetitive back-and-forth handovers.

To mitigate those impairments and uncertainty, and thereby to prevent erroneous decisions, those raw measurements are filtered. Filtering may comprise, for example, filtering by moving average filter, i.e. layer 1 (L1) filter, and recursive filter, i.e. layer 3 (L3) filter, which provide smooth and more accurate measurement at the expense of the additional delay in the measurements due to filtering.

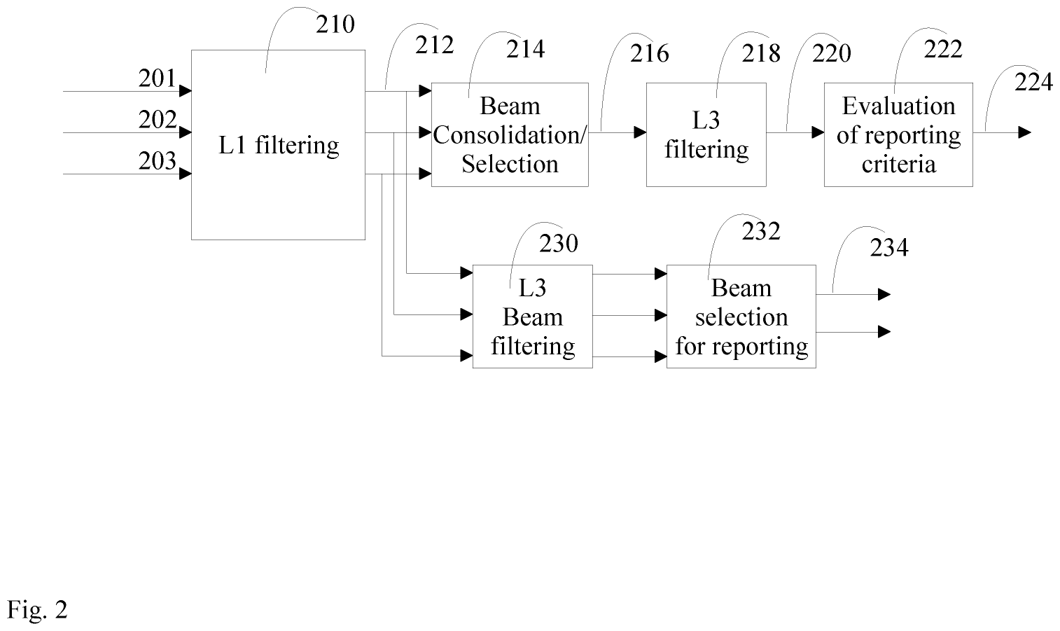

FIG. 2 shows, by way of example, a measurement model of a user equipment. The 3rd generation partnership project (3GPP) technical specification (TS) 38.300, section 9.2.4, defines the measurement model for UEs in radio resource control (RRC) connected mode. Herein, the UE measures at least one beam 201, 201, 203 of a cell, e.g. a cell controlled by a gNB. In case of multiple beams, the measurements results, e.g. power values, may be averaged to derive the cell quality. This way, the UE is configured to consider a subset of the detected beams.

Filtering takes place at two different levels: at the physical layer, L1 to derive beam quality and then at RRC level, L3, to derive cell quality from multiple beams. Cell quality from beam measurements may be derived in the same manner for both serving cell(s) and non-serving cell(s).

The beams 201, 202, 203 are measurements to obtain beam specific samples. The measurements are internal to the physical layer.

Internal layer 1, L1, filtering 210 filters the measurements of the beams 201, 202, 203. Filtering 210 includes measurement averaging and is UE implementation specific.

Beam specific measurements 212 reported by L1 filtering are input to layer 3. L3. Parameters for beam consolidation or selection 214 may be configured via RRC signalling. Beam specific measurements are consolidated to derive cell quality 216.

Cell quality 216 is filtered by L3 filtering 218, for which the parameters may be configured via RRC signalling.

L3 filter 218 is a recursive filter, for example one which is defined in 3GPP TS 38.331 section 5.5.3.2 and expressed as

$${F}_{n} = ( 1 - a ) \times {F}_{n - 1} + a \times {M}_{n} .$$

Herein, Fₙ is current L3 filter output (220 in FIG. 2), Fₙ₋₁ is previous L3 filter output and Mₙ is current L3 filter input (216 in FIG. 2). a is the forgetting factor of recursive filter defined as

$$a = \frac{1}{{2}^{\frac{k}{4}}}$$

and k is the filter coefficient that is configured by the network to determine time characteristics of the L3 filter. The filter is adapted such that the time characteristics of the filter are preserved at different input rates, observing that the filter coefficient k assumes a sample rate equal to X ms. The value of X is equivalent to one intra-frequency L1 measurement period.

Output 220 from L3 filtering is used as input for evaluation of reporting criteria 222.

Evaluation of reporting criteria 222 may be configured via RRC signalling. The UE may evaluate the reporting criteria at least every time a new measurement result is reported, for example.

Output 224 from the evaluation is a measurement report. The measurement report 224 is sent on the radio interface.

Parameters for L3 beam filtering 230 and beam selection for reporting 232 may be configured via RRC signalling. Selected beams are reported in the measurement report 234, which is sent on the radio interface.

How and when the UE performs the L1 filtering 210 is implementation specific to the point that the output 216, that is, the cell quality fulfils performance requirements set in TS 38.133. L1 synchronization signal block reference signal received power (SSB-RSRP) intra-frequency measurement requirements have been defined as absolute accuracy and relative accuracy in FR2. The defined accuracy requirements set the lower limits for the L1 implementation accuracy. L1 filter implementation of a UE may accommodate better accuracy than required. However, there is a tradeoff between accuracy and the delay caused by the measurements. More accurate L1 measurements cause delay on the measurements, because of large number of samples to be averaged over time. Fast L1 measurements lead to inaccurate measurements, because of a small number of samples to be averaged over time.

The same tradeoff exist for L3 filtering, which is configured and controlled by the network. Configuring L3 filter time constant k to a larger value means that forgetting factor a of the L3 filter is configured to a smaller value which leads L3 filter measurements to be smooth, or less fluctuating, and accurate at the expense of increased delay. The delay is dependent on the previous measurements in the memory as memory factor (1-a) would become larger.

L3 measurements (220 in FIG. 2) are used by the UE to evaluate the measurement reporting criteria and possibly initiate the handover procedure. The measurements and filtering are cascaded so that physical layer raw measurements 201, 202, 203 are first filtered by L1 filter 210 and then the output of L1 filter is further filtered by L3 filter 218. Thus, accuracy and delay introduced by both L1 filter and L3 filter are also cascaded.

The L1 filter may be referred to as a first filter or a filter of a first layer. The first layer is the physical layer of the 5G protocol stack, for example. The L3 filter may be referred to as a third filter or a filter of a third layer. The third layer may be the RRC layer. In the context of low layer mobility (LLM), L2 filter may be referred to as a second filter or a filter of a second layer. The second layer may be a medium access control (MAC) sublayer.

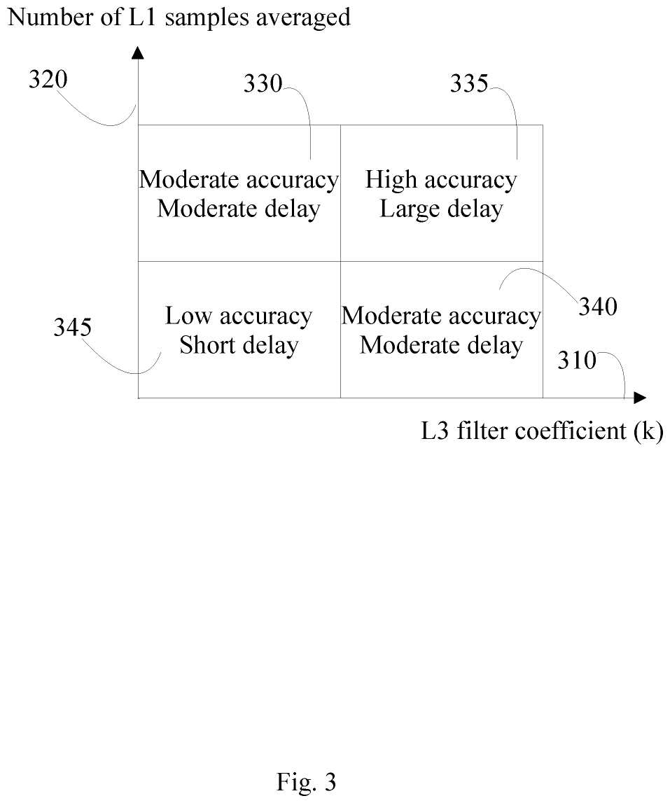

FIG. 3 shows, by way of example, accuracy-delay impact and tradeoff for cascaded L1 and L3 filter configurations. The x-axis 310 shows the L3 filter coefficient k and y-axis 320 shows the number of L1 samples averaged over time. Regions 330, 340 show reasonable operation areas, wherein measurements have moderate accuracy and moderate delay. Region 330 is characterized by high number of L1 samples averaged and small L3 filter coefficient k. Region 340 is characterized by low number of L1 samples averaged and large L3 filter coefficient k.

Regions 335, 345 show unreasonable operation areas. Region 335 is characterized by high number of L1 samples averaged and large L3 filter coefficient k. This kind of configuration causes high accuracy and large delay. Region 345 is characterized by low number of L1 samples averaged and small L3 filter coefficient k. This kind of configuration causes low accuracy and short delay.

As described, the lower limits of the L1 implementation accuracy on the UE side have been set, but UE may implement the L1 filter with higher accuracy. However, even though the network knows the limits defined in the specifications, the network is not aware of how accurate the L1 filter implementation is and how much L1 filter measurements are delayed.

For example, let us assume that the network configures large L3 filter coefficient k. Large L3 filter coefficient leads accurate L3 filter at the expense of delayed measurements. If L1 filter measurements are not accurate (although they satisfy the accuracy requirements of Table 1 and Table 2, L1 filter may operate under minimum requirements), cascade L1 and L3 filter measurements will be reasonably (not too much) delayed and also accurate due to L3 filter configuration. However, it is not known by the network how accurate the L1 filter implementation is, and the network has configured the L3 filter with large filter coefficient to be on the safe side. If the L1 filter implementation is also accurate and the averaging causes delay on the L1 filter measurements, cascade L1 and L3 filter leads to unnecessarily accurate measurements and excessively delayed measurements. This example situation is illustrated by the region 335 in FIG. 3.

As another example, network may configure small L3 filter coefficient k which leads L3 filter measurements to be less accurate for the sake of undelayed measurements. If the L1 filter implementation of the UE is designed in a way that it produced accurate measurements (beyond the accuracy defined in Table 1 and Table 2), cascade L1 and L3 filter structure would result in reasonably accurate and delayed measurements. However, it is possible that L1 filter of the UE also produces inaccurate and undelayed measurements, for example, by operating at minimum accuracy requirements defined in the specifications. This example situation causes cascade L1 and L3 filter measurement results to be unreliable due to extremely inaccurate measurements. This example situation is illustrated by the region 345 in FIG. 3.

Thus, it is not transparent to network how accurate and delayed the L1 filter measurements are as the L1 filtering is UE implementation specific. A mismatch may occur between L1 filter designs and L3 filter configuration. This, under certain circumstances, may lead to, for example, unnecessarily accurate and extremely delayed L3 measurements, which increases the risk of delayed handover decisions and failures. As another example, network not being aware of L1 filtering implementation may lead to unreliable and very fast L3 measurements, which increases the risk of unnecessary handovers, e.g., ping-pong (PP) or short stays (SS).

Methods and apparatuses configured to perform the methods are provided for coordinating the L3 filter configuration and L1 filter properties of UE L1 filter implementation. The properties of the filter comprise, for example, accuracy and thereby the delay of the filter.

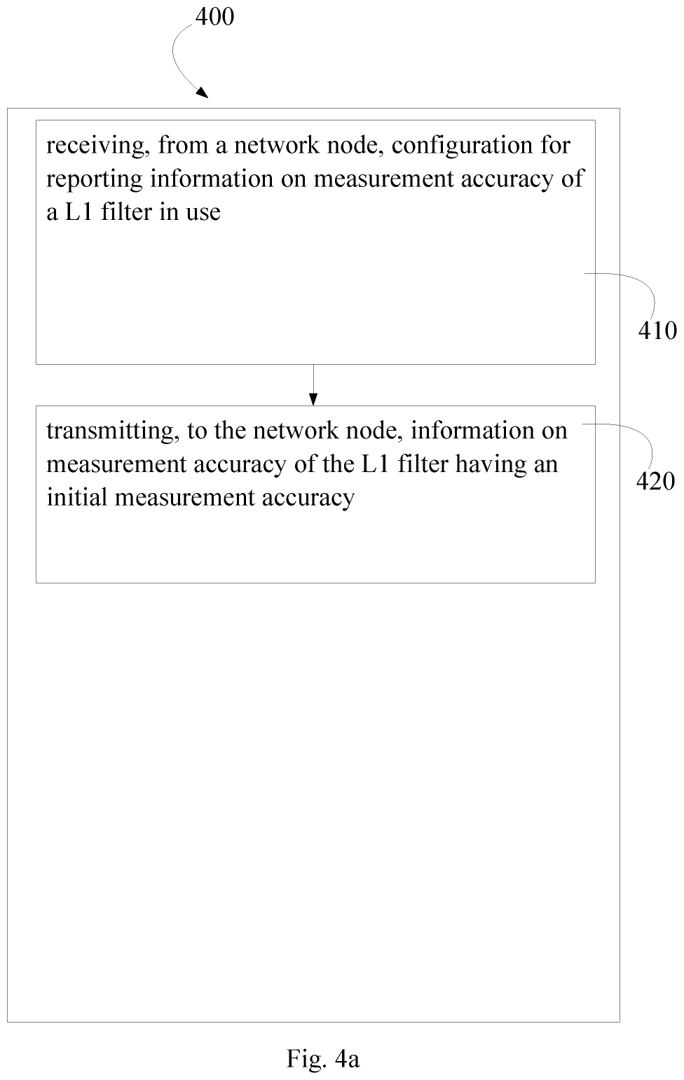

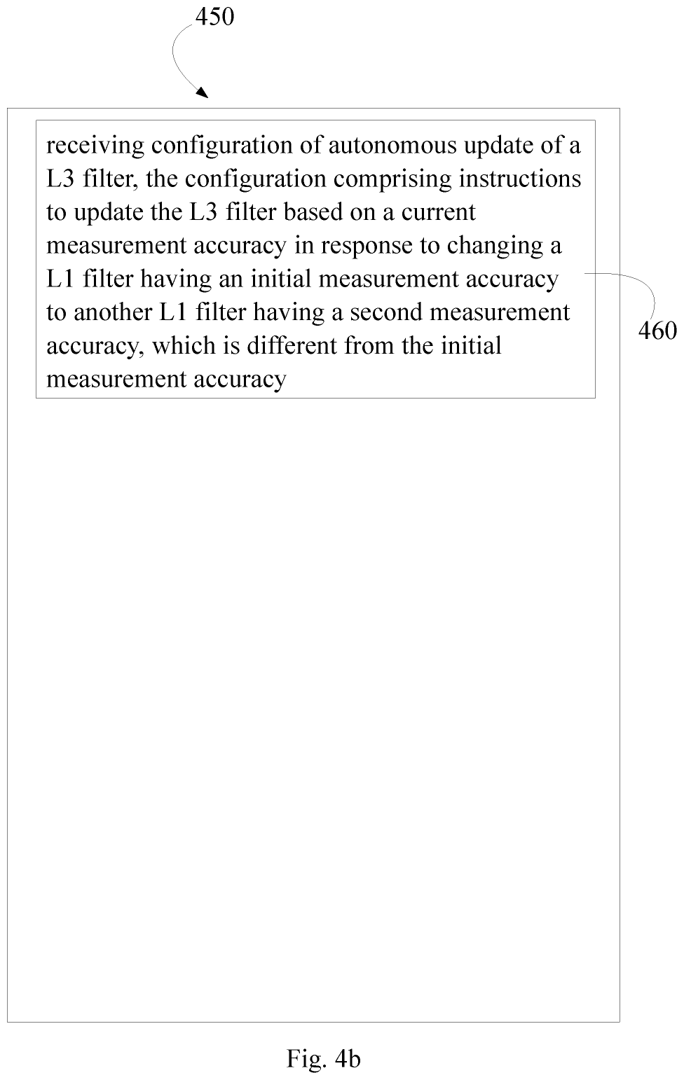

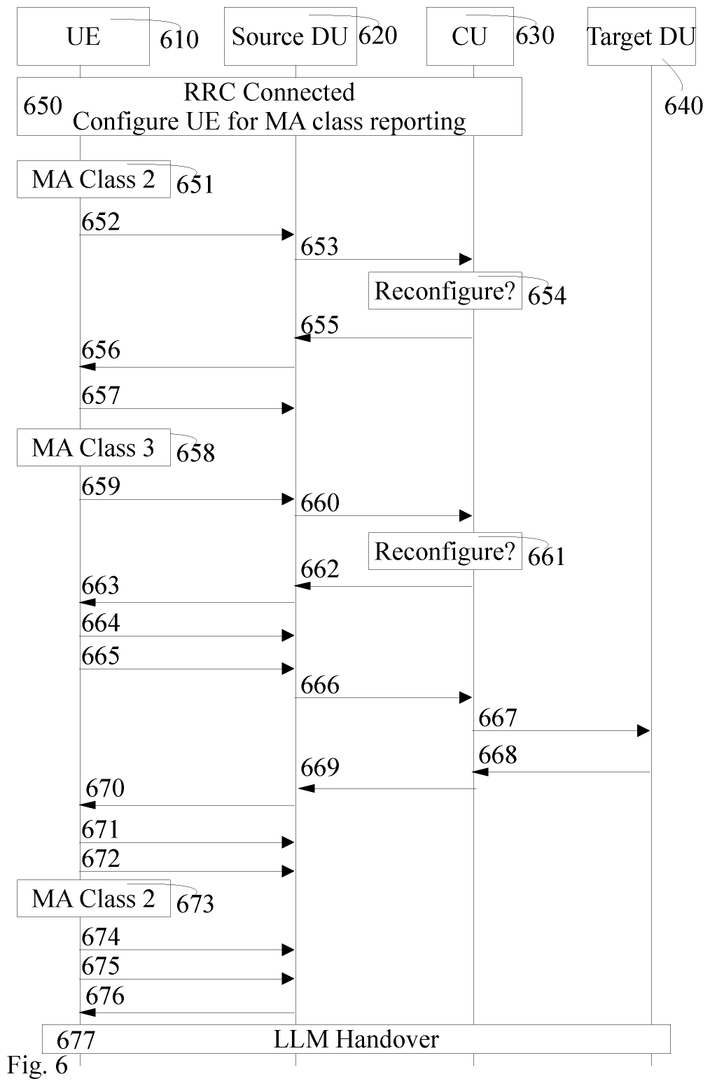

FIG. 4a shows, by way of example, a flowchart of a method 400. The method may be performed by a user equipment or by a control device configured to control the functioning thereof, when installed therein. The UE may be, for example, the device 610 of FIG. 6, which is configured to perform at least the method 400. The method 400 comprises receiving 410, from a network node, configuration for reporting information on measurement accuracy of a L1 filter in use. The method 400 comprises transmitting 420, to the network node, information on measurement accuracy of the L1 filter having an initial measurement accuracy.

FIG. 4b shows, by way of example, a flowchart of a method 450. The method may be performed by a user equipment or by a control device configured to control the functioning thereof, when installed therein. The UE may be, for example, the device 610 of FIG. 6, which is configured to perform at least the method 450. The method 450 comprises receiving 460 configuration of autonomous update of a L3 filter, the configuration comprising instructions to update the L3 filter based on a current measurement accuracy in response to changing a L1 filter having an initial measurement accuracy to another L1 filter having a second measurement accuracy, which is different from the initial measurement accuracy.

Information on measurement accuracy may be given, for example, using different measurement accuracy classes, MA classes. A mapping may be defined between different levels of measurement accuracy and MA classes. MA classes may define different level of accuracy requirements to be met for UEs, which claim they are capable of satisfying the MA class requirements. MA classes may be mapped to accuracy requirements that have been defined in 3GPP TS 38.133. For example, default MA class may define that the UE is capable of providing the minimum requirements. The UEs that are capable of providing better measurement accuracy than the minimum requirements may be subject to a test which proves that UE is capable of providing better accuracy than the default MA class.

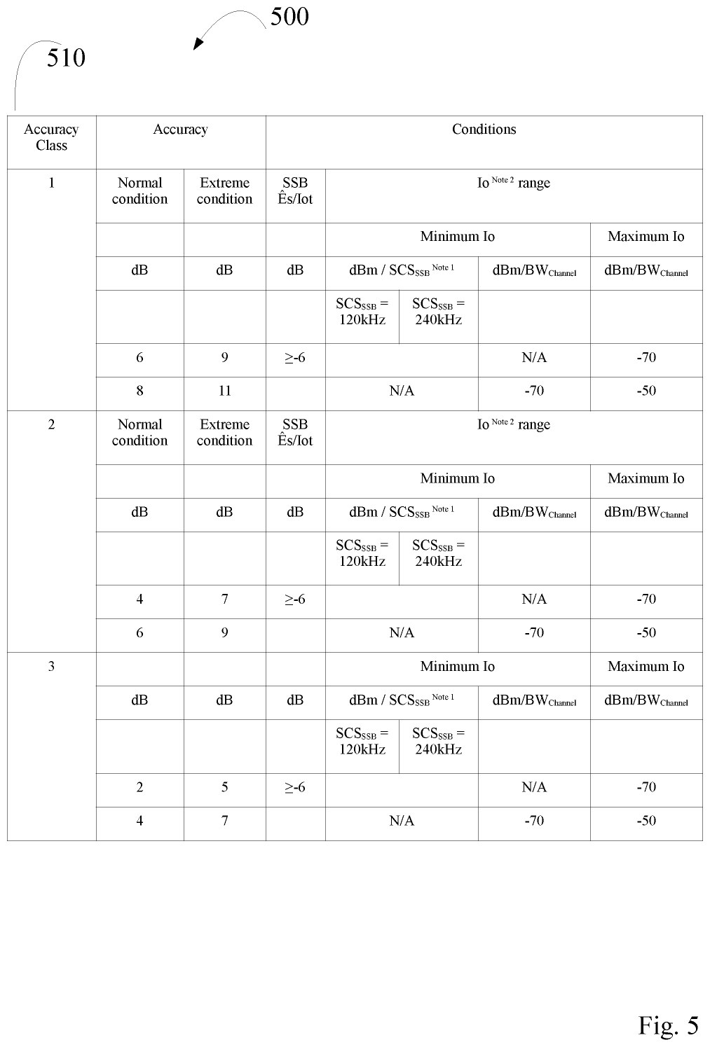

For example, an extra column may be added to the measurement accuracy requirements tables of TS 38.133. The extra column may be titled as “Accuracy class” or “MA class” or similar. Rows in the MA class column identify different level of MA class that requires different measurement accuracies to be met by UE L1 filter implementation. FIG. 5 shows, by way of example, measurement accuracy requirements of layer 1 filter.

Reporting information on measurement accuracy, e.g. using MA classes, enables UEs to provide more granular information to the network about the measurement accuracy of L1 filter that is currently in use. The method as disclosed herein enables a UE to provide information about the level of accuracy of L1 filtering, and thereby the delay, to the network without necessarily revealing any L1 filter implementation details. Hence, the network is enabled to use this information to configure the L3 filter or L2 filter in coordination with the L1 filter characteristics. Configuration of L3 filter relates to L3 mobility and configuration of L2 filter relates to low layer mobility (LLM). The method as disclosed herein enables to network to avoid operating in unwanted regions as shown by regions 335, 345 in FIG. 3. Eventually, the method as disclosed herein enables the network to prevent mobility failures caused by unnecessarily delayed measurements or ping-pongs and short stays caused by extremely inaccurate measurements.

Referring back to FIG. 5, the example table 500 shows three MA classes in the MA class column 510. It is to be noted that the MA classes shown are illustrative, i.e., there may be less than three MA classes, e.g., only two MA classes, or more than three MA classes. Besides, the accuracy margin of each class for normal and extreme conditions may be different than what is shown in the example table of FIG. 5. MA class 1 may be considered as a default class. That is, the default class may be based on the minimum L1 filter measurement accuracy requirements.

For example, multiple MA classes may be defined such that higher MA class require stricter measurement accuracy margin than a lower class. For example, if there are more than one MA class, e.g., three MA classes defined, accuracy margin of MA Class 2, ±σ₂ may be defined to be smaller than that of MA Class 1 ±σ₁ (±6 dB). That is, σ₂<σ₁ for σ₁, σ₂>0. Similarly, accuracy margin of MA Class 3 may be defined smaller than that of MA Class 2. That is, σ₃<σ₂ for σ₂, σ₃>0.

The method of FIG. 4 and embodiments thereof will be described in more detail in the context of FIG. 6.

FIG. 6 shows, by way of example, signalling between entities. The UE 610 is currently served by a network node, e.g. gNB, which comprises a source distributed unit (DU) 620. The UE may handover from the source DU 620 to another network node, e.g. gNB, which comprises a target DU 640. The centralized unit (CU) 630 is configured to, for example, coordinate RRC and handover decision-making process.

The UE 610 is connected 650 to source DU 620. The UE receives 650 RRC related configurations, for example, measurement configuration, mobility parameters and L3 filter configurations, from the network.

The UE 610 receives 650, from a network node, configuration for reporting information on measurement accuracy of a first filter, e.g. of a L1 filter. For example, network configures UE 610 to report information on measurement accuracy of the L1 filter, e.g. as defined by MA class, to the source DU 620 once the UE 610 is RRC connected. Thus, the UE is configured to report the initial MA class of L1 filter in use by the UE 610.

The UE is configured to report information on measurement accuracy of the L1 filter to the source DU 620 in response to an update of the MA class. For example, if the UE starts to use a different L1 filter, which satisfies different MA class requirements than the filter used initially, the UE is configured to report the update of the MA class to the network.

The UE 610 decides 651 to use a L1 filter that meets the accuracy requirements of MA class 2. In other words, the UE decides to use a first filter having an initial measurement accuracy, or first measurement accuracy. For example, the initial measurement accuracy may be defined by MA class 2.

The UE 610 transmits 652, to the network, the initial MA class of L1 filter in use. In other words, the UE transmits information on measurement accuracy of the first filter having the initial measurement accuracy.

The source DU 620 receives, from the UE 610, information on the measurement accuracy of the first filter, and transmits 653 or relays this information to another network node, e.g. the CU 630.

The CU 630 receives information on the measurement accuracy of the first filter. The CU 630 is configured to determine 654 whether to reconfigure the L3 filter of the UE 610. For example, the CU is configured to analyse the information on measurement accuracy of the first filter and the current configuration of the L3 filter to decide whether the current configuration leads unwanted operation regime. The unwanted operation regime refers to the regions 335 and 345 shown in FIG. 3. The CU uses knowledge of impact of the measurement accuracy of the L1 filter and the configuration of the L3 filter on performance of a cascade of the L1 filter and the L3 filter in deciding whether to reconfigure the L3 filter.

In response to determining that the L3 filter is to be reconfigured, the CU 630 reconfigures the L3 filter and transmits 655 the reconfiguration to the DU 620. For example, the CU 630 may decide to increase the filter coefficient k of the L3 filter to improve the accuracy of the filter with reasonable delay. As another example, the CU 630 decides to decrease the filter coefficient k of the L3 filter to mitigate delay on the measurements and avoid unnecessarily accurate measurements. Thus, the reconfiguration may comprise an updated filter coefficient for L3 filter. For example, the updated filter coefficient may be larger than previously.

The DU 620 transmits 656 or relays the reconfiguration of the L3 filter to the UE 610.

The UE 610 receives 656 the reconfiguration of the L3 filter, applies the new reconfiguration and updates the L3 filter. The UE 610 may send 657 acknowledgement of the update to the network.

The UE 610 may decide to change 658 the L1 filter in use to another L1 filter implementation. In other words, the UE may change the L1 filter, having the initial measurement accuracy, to another L1 filter having a second measurement accuracy, which is different from the initial measurement accuracy. For example, the UE 610 may start using L1 filter that satisfies higher MA class than the L1 filter currently in use. For example, the MA class of the L1 filter may change from 2 to 3.

The UE 610 transmits 659, to the source DU 620, information on the second measurement accuracy. For example, the UE reports the updated MA class, e.g. MA class 3, to the DU 620 as it was configured 650 by the network.

The source DU 620 receives 659, from the UE 610, information on the updated measurement accuracy of the L1 filter, and transmits 660 or relays this information to the CU 630.

The CU 630 receives information on the updated measurement accuracy of the L1 filter. As above, in 654, the CU 630 is configured to determine whether to reconfigure the L3 filter.

In response to determining that the L3 filter is to be reconfigured, the CU 630 reconfigures the L3 filter and transmits 662 the reconfiguration to the DU 620. The reconfiguration may comprise an updated filter coefficient for L3 filter. For example, the updated filter coefficient may be smaller than previously.

The DU 620 transmits 663 or relays the reconfiguration of the L3 filter to the UE 610.

The UE 610 receives 663 the reconfiguration of the L3 filter, applies the new reconfiguration and updates the L3 filter. The UE 610 may send 664 acknowledgement of the update to the network.

When measurement report triggering condition is met at the UE side, the UE sends 665 a measurement report to initiate a low layer mobility (LLM) procedure. The DU 620 relays 666 the report to the CU 630, which prepares the target DU 640 by transmitting 667 UE context setup request to the target DU 640.

The target DU 640 responds by transmitting 668 UE context setup response to the CU 630.

Once the target DU 640 is prepared, the CU 630 generates a new RRC reconfiguration to be applied on the UE side during LLM. The CU transmits 669 the reconfiguration to the DU 620, which relays 670 the reconfiguration to the UE 610. The UE is configured to measure target signal and report periodic L1 beam measurements of both serving and non-serving cell(s). In addition, the UE is configured to report information on measurement accuracy, e.g. MA class, along with the L1 beam measurements. For example, the UE may be configured to report the MA class in case the UE starts using different L1 filter that meets different accuracy requirements. For example, if the MA class is updated or changed, the UE reports the updated MA class together with the L1 beam measurements.

The network configures 669 the DU 620 to update the L2 filter configuration for different MA class, if the DU 620 receives an update of the MA class from the UE 610.

Thus, the information on measurement accuracy of the L1 filter, e.g. MA class information, may be used during LLM. When UE 610 reports MA class information to the DU 620, the DU 620 updates the L2 filter configuration accordingly.

The DU 620 transmits 670 a reconfiguration to the UE 610. The reconfiguration comprises a configuration for reporting information on measurement accuracy together with the L1 beam measurements, if measurement accuracy is updated.

The UE 610 may send 671 acknowledgement of the reconfiguration to the network.

The UE starts 672 reporting L1 beam measurements. Since there has not been any update in the MA class, the UE does not necessarily include the MA class information in the measurement report.

The UE changes 673 the measurement accuracy of the L1 filter, for example, from MA Class 3 to MA class 2.

The UE reports 674 the L1 beam measurements together with the information on the updated measurement accuracy, e.g. on the MA class change. For example, the UE may include the new MA class in the reported L1 beam measurement, according to the reconfiguration received 670.

The DU receives the measurement report together with the updated measurement accuracy information, and may updated the L2 filter configuration, as configured 669.

The UE may continue with measurement reporting 675. The source DU 620 may trigger 676 a cell change. The UE handovers 677 from the source DU 620 to the target DU 640.

According to an embodiment, the network may configure 650 the UE 610 with autonomous update of L3 filter configuration. For example, the configuration of autonomous update may define L3 filter coefficient for different MA classes. In other words, there may be a mapping between the filter coefficients and MA classes. Whenever the UE updates the MA class, the UE may autonomously update the L3 filter according to the configuration.

As another example, the network may configure the UE to scale the L3 filter coefficient with respect to the MA class of the UE L1 filter that is currently in use. For example, if the current filter coefficient is k, and the current MA class is 1. Then, if the updated MA class is 2, the UE may scale, according to the configuration, the filter coefficient with a scaling factor ½ to set k to k/2. If the MA class is further increased, the L3 filter coefficient is scaled further either with the same scaling factor ½ to set k/2 to k/4 or different scaling factor ⅓ to set k/2 to k/6.

Configuration of the autonomous update enable updating of the L3 filter configuration autonomously in response to a change in the measurement accuracy of the first filter such that extra signalling between the UE and the network entities CU and DU is decreased or avoided.

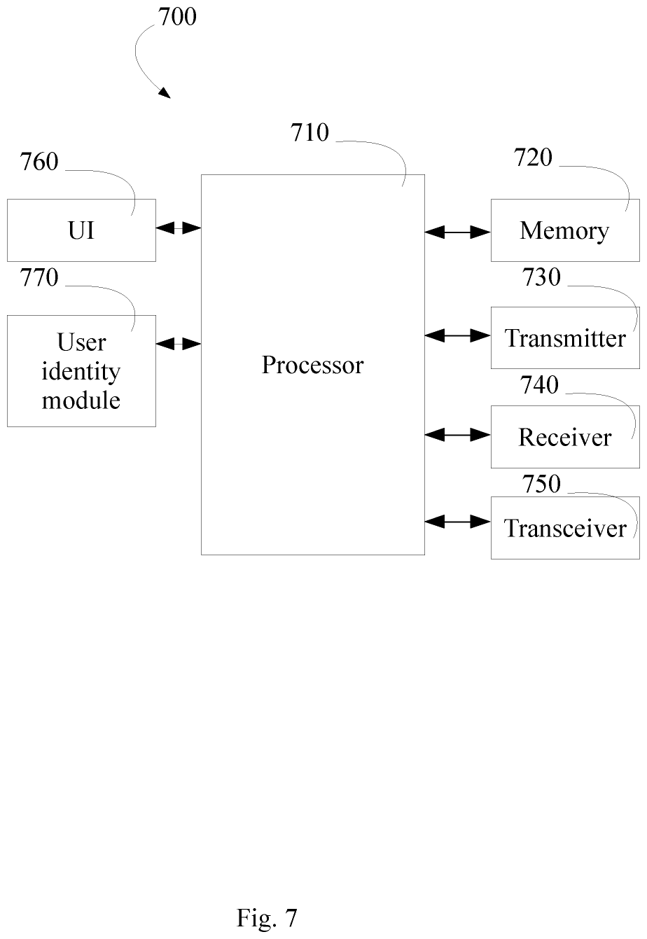

FIG. 7 shows, by way of example, an apparatus capable of performing the methods as disclosed herein. Illustrated is device 700, which may comprise, for example, a mobile communication device such as mobile or UE 610 of FIG. 6 or a network node 620, 630 of FIG. 6. Comprised in device 700 is processor 710, which may comprise, for example, a single- or multi-core processor wherein a single-core processor comprises one processing core and a multi-core processor comprises more than one processing core. Processor 710 may comprise, in general, a control device. Processor 710 may comprise more than one processor. Processor 710 may be a control device. A processing core may comprise, for example, a Cortex-A8 processing core manufactured by ARM Holdings or a Steamroller processing core designed by Advanced Micro Devices Corporation. Processor 710 may comprise at least one Qualcomm Snapdragon and/or Intel Atom processor. Processor 710 may comprise at least one application-specific integrated circuit, ASIC. Processor 710 may comprise at least one field-programmable gate array, FPGA. Processor 710 may be means for performing method steps in device 700. Processor 710 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a mobile phone, UE, or a network node, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 700 may comprise memory 720. Memory 720 may comprise random-access memory and/or permanent memory. Memory 720 may comprise at least one RAM chip. Memory 720 may comprise solid-state, magnetic, optical and/or holographic memory, for example. Memory 720 may be at least in part accessible to processor 710. Memory 720 may be at least in part comprised in processor 710. Memory 720 may be means for storing information. Memory 720 may comprise computer instructions that processor 710 is configured to execute. When computer instructions configured to cause processor 710 to perform certain actions are stored in memory 720, and device 700 overall is configured to run under the direction of processor 710 using computer instructions from memory 720, processor 710 and/or its at least one processing core may be considered to be configured to perform said certain actions. Memory 720 may be at least in part external to device 700 but accessible to device 700.

Device 700 may comprise a transmitter 730. Device 700 may comprise a receiver 740. Transmitter 730 and receiver 740 may be configured to transmit and receive, respectively, information in accordance with at least one cellular or non-cellular standard. Transmitter 730 may comprise more than one transmitter. Receiver 740 may comprise more than one receiver. Transmitter 730 and/or receiver 740 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 700 may comprise a near-field communication, NFC, transceiver 750. NFC transceiver 750 may support at least one NFC technology, such as NFC, Bluetooth, Wibree or similar technologies.

Device 700 may comprise user interface, UI, 760. UI 760 may comprise at least one of a display, a keyboard, a touchscreen, a vibrator arranged to signal to a user by causing device 700 to vibrate, a speaker and a microphone. A user may be able to operate device 700 via UI 760, for example to accept incoming telephone calls, to originate telephone calls or video calls, to browse the Internet, to manage digital files stored in memory 720 or on a cloud accessible via transmitter 730 and receiver 740, or via NFC transceiver 750, and/or to play games.

Device 700 may comprise or be arranged to accept a user identity module 770. User identity module 770 may comprise, for example, a subscriber identity module, SIM, card installable in device 700. A user identity module 770 may comprise information identifying a subscription of a user of device 700. A user identity module 770 may comprise cryptographic information usable to verify the identity of a user of device 700 and/or to facilitate encryption of communicated information and billing of the user of device 700 for communication effected via device 700.

Processor 710 may be furnished with a transmitter arranged to output information from processor 710, via electrical leads internal to device 700, to other devices comprised in device 700. Such a transmitter may comprise a serial bus transmitter arranged to, for example, output information via at least one electrical lead to memory 720 for storage therein. Alternatively to a serial bus, the transmitter may comprise a parallel bus transmitter. Likewise processor 710 may comprise a receiver arranged to receive information in processor 710, via electrical leads internal to device 700, from other devices comprised in device 700. Such a receiver may comprise a serial bus receiver arranged to, for example, receive information via at least one electrical lead from receiver 740 for processing in processor 710. Alternatively to a serial bus, the receiver may comprise a parallel bus receiver.

Processor 710, memory 720, transmitter 730, receiver 740, NFC transceiver 750, UI 760 and/or user identity module 770 may be interconnected by electrical leads internal to device 700 in a multitude of different ways. For example, each of the aforementioned devices may be separately connected to a master bus internal to device 700, to allow for the devices to exchange information. However, as the skilled person will appreciate, this is only one example and depending on the embodiment various ways of interconnecting at least two of the aforementioned devices may be selected.

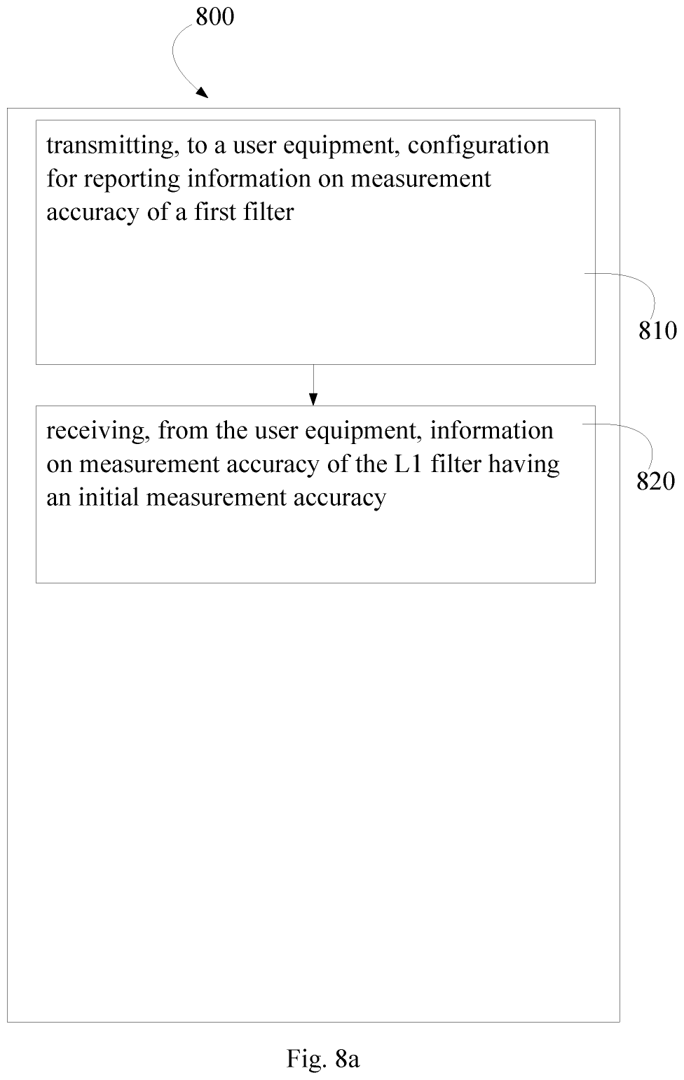

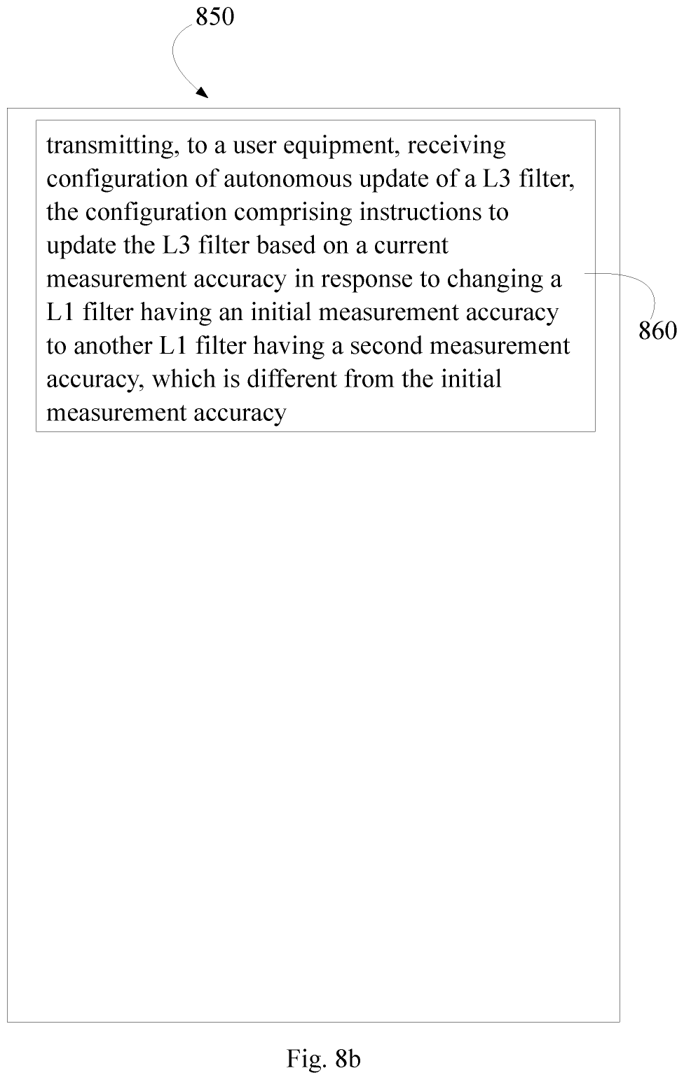

FIG. 8a shows, by way of example, flowchart of a method. The method 800 may be performed by a network node or by a control device configured to control the functioning thereof, when installed therein. The network node may be a source DU or source gNB-DU, for example, the device 620 of FIG. 6, which is configured to perform at least the method 800. The method 800 comprises transmitting 810, to a user equipment, configuration for reporting information on measurement accuracy of a first filter. The method 800 comprises receiving 820, from the user equipment, information on measurement accuracy of the L1 filter having an initial measurement accuracy.

FIG. 8b shows, by way of example, flowchart of a method. The method 850 may be performed by a network node or by a control device configured to control the functioning thereof, when installed therein. The network node may be a source DU or source gNB-DU, for example, the device 620 of FIG. 6, which is configured to perform at least the method 850. The method 850 comprises transmitting 860, to a user equipment, receiving configuration of autonomous update of a L3 filter, the configuration comprising instructions to update the L3 filter based on a current measurement accuracy in response to changing a L1 filter having an initial measurement accuracy to another L1 filter having a second measurement accuracy, which is different from the initial measurement accuracy.

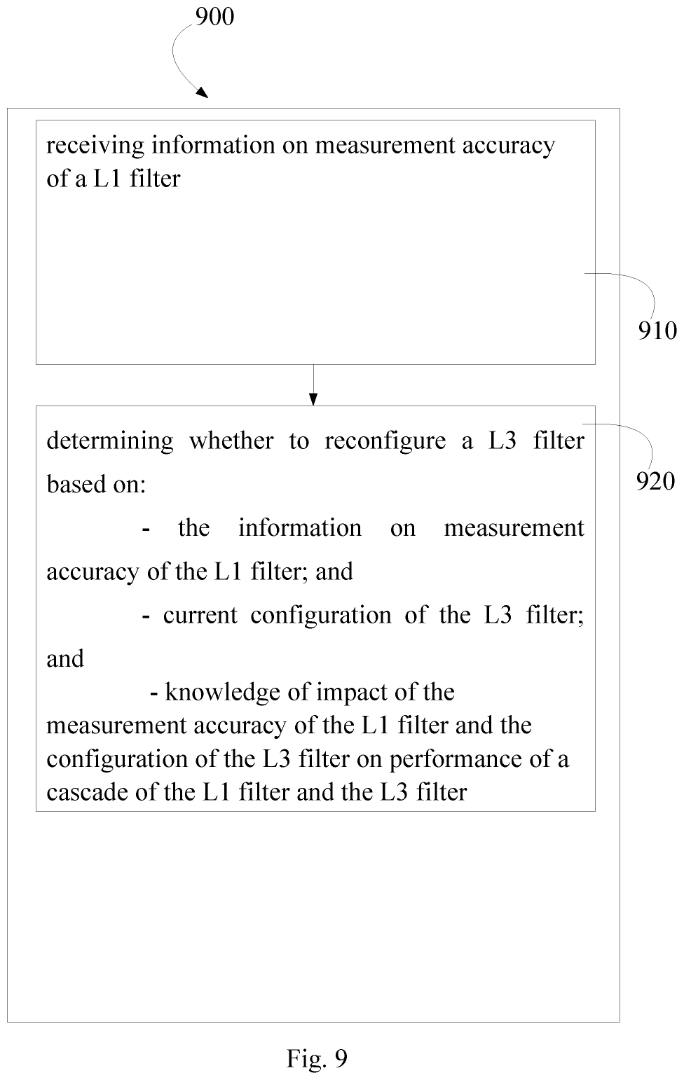

FIG. 9 shows, by way of example, flowchart of a method. The method 900 may be performed by a network node or by a control device configured to control the functioning thereof, when installed therein. The network node may be a CU or gNB-CU, for example, the device 620 of FIG. 6, which is configured to perform at least the method 900. The method 900 comprises receiving 910 information on measurement accuracy of a L1 filter. The method 900 comprises determining 920 whether to reconfigure a L3 filter based on: the information on measurement accuracy of the L1 filter; and current configuration of the L3 filter; and knowledge of impact of the measurement accuracy of the L1 filter and the configuration of the L3 filter on performance of a cascade of the L1 filter and the L3 filter.

1-20. (canceled)

21. An apparatus comprising at least one processor; and at least one memory including computer program code, the at least one memory and the computer program code configured to, with the at least one processor, cause the apparatus to perform at least:
receiving, from a network node, configuration for reporting information on measurement accuracy of a L1 filter in use; and
transmitting, to the network node, information on measurement accuracy of the L1 filter having an initial measurement accuracy.

22. The apparatus of claim 21, wherein the L1 filter is a filter of a first layer.

23. The apparatus of claim 21, further configured to perform:
receiving, from the network node, reconfiguration of a L3 filter.

24. The apparatus of claim 23,
wherein the reconfiguration comprises increasing a filter coefficient of the L3 filter; or
decreasing a filter coefficient of the L3 filter.

25. The apparatus of claim 23,
wherein the L3 filter is a filter of a third layer.

26. The apparatus of claim 23, further configured to perform:
updating the L3 filter according to the reconfiguration.

27. The apparatus of claim 21, further configured to perform:
changing the L1 filter to another L1 filter having a second measurement accuracy, which is different from the initial measurement accuracy; and
transmitting, to the network node, information on the second measurement accuracy.

28. The apparatus of claim 27, further configured to perform:
receiving, from the network node, reconfiguration of a L3 filter which has been updated in response to a change in the measurement accuracy of the L1 filter; and
updating the L3 filter according to the reconfiguration.

29. An apparatus comprising at least one processor; and at least one memory including computer program code, the at least one memory and the computer program code configured to, with the at least one processor, cause the apparatus to perform at least:
receiving configuration of autonomous update of a L3 filter, the configuration comprising instructions to update the L3 filter based on a current measurement accuracy in response to changing a L1 filter having an initial measurement accuracy to another L1 filter having a second measurement accuracy, which is different from the initial measurement accuracy.

30. The apparatus of claim 29,
wherein the configuration of autonomous update comprises a plurality of different filter coefficients of the L3 filter corresponding to different measurement accuracies.

31. The apparatus of claim 29,
wherein the configuration of autonomous update comprises instructions to scale a filter coefficient of the L3 filter with respect to the current measurement accuracy of the L1 filter.

32. The apparatus of claim 29, further configured to:
changing the L1 filter to another L1 filter having the second measurement accuracy, which is different from the initial measurement accuracy; and
in response to changing, updating the L3 filter according to the configuration of autonomous update.

33. The apparatus of claim 29,
wherein the measurement accuracy of the L1 filter is defined by a measurement accuracy class.

34. An apparatus comprising at least one processor; and at least one memory including computer program code, the at least one memory and the computer program code configured to, with the at least one processor, cause the apparatus to perform at least:
a) transmitting, to a user equipment, configuration for reporting information on measurement accuracy of a first filter; and
receiving, from the user equipment, information on measurement accuracy of the L1 filter having an initial measurement accuracy; or
b) transmitting, to a user equipment, receiving configuration of autonomous update of a L3 filter, the configuration comprising instructions to update the L3 filter based on a current measurement accuracy in response to changing a L1 filter having an initial measurement accuracy to another L1 filter having a second measurement accuracy, which is different from the initial measurement accuracy.

35. The apparatus of claim 34, further configured to perform after option a): transmitting, to another network node (CU), information on measurement accuracy of the L1 filter.

36. The apparatus of claim 34, further configured to perform:
receiving, from a network node, configuration for updating a L2 filter configuration based on the received information on the measurement accuracy of the L1 filter or based on received information on a change of the L1 filter to another L1 filter having a second measurement accuracy, which is different from the initial measurement accuracy.

37. The apparatus of claim 36, further configured to perform:
receiving, from the user equipment, information on a change of the L1 filter to another L1 filter having the second measurement accuracy, which is different from the initial measurement accuracy; and
updating the L2 filter configuration based on the information on the second measurement accuracy.

38. An apparatus comprising at least one processor; and at least one memory including computer program code, the at least one memory and the computer program code configured to, with the at least one processor, cause the apparatus to perform at least:
receiving information on measurement accuracy of a L1 filter;
determining whether to reconfigure a L3 filter based on:
the information on measurement accuracy of the L1 filter; and
current configuration of the L3 filter; and
knowledge of impact of the measurement accuracy of the L1 filter and the configuration of the L3 filter on performance of a cascade of the L1 filter and the L3 filter.

39. The apparatus of claim 38, further configured to perform:
in response to determining that the L3 filter is to be reconfigured, reconfiguring the L3 filter and transmitting the reconfiguration of the L3 filter.

40. The apparatus of claim 39,
wherein the reconfiguration comprises increasing a filter coefficient of the L3 filter; or
decreasing a filter coefficient of the L3 filter.
